(19) United States
(12) Patent Application Publication
(10) Pub. No.: US 2006/0203815 A1
(43) Pub. Date: Sep. 14, 2006

(54) Compliance verification and OSI layer 2 connection of device using said compliance verification

(76) Inventor: Alain Couillard, L'Ancienne-Lorette (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/075,658

(22) Filed: Mar. 10, 2005

(51) Int. Cl. H04L 12/56; H04L 12/28; H04L 12/66

(52) U.S. Cl. 370/389

(57) ABSTRACT

The method comprises installing an agent software on the device; detecting a boot-up of the device; providing the device with a temporary IP address upon boot-up, the temporary IP address being within a compliancy network, logically separate from the corporate network; providing a list of compliance rules to be verified for the device; sending the agent the list of compliance rules; verifying a state of the device for each rule; transmitting a result of the state obtained for each compliance rule; deciding on compliance of the device using the result; instructing a switch port at OSI layer 2 to connect the device to the corporate network if the decision determines compliance; instructing a switch port at OSI layer 2 to connect the device to a network logically separate from the corporate network in case of non-compliance.

### BACKGROUND OF THE INVENTION

1) Field of the Invention

The invention relates to verification of compliance of a device connecting to a corporate network (for example a Local Area Network (LAN)) at Open System Interconnection (OSI) Data Link Layer 2 and connection of the device according to a result of the compliance verification.

2) Description of the Prior Art

Information Technology (IT) networks are more and more attacked from the inside via vulnerable workstations instead of via traditional hackers from the outside. The evolution of threats and vulnerabilities in IT environments poses a serious challenge to the integrity of corporate infrastructures, The division between the trusted network and untrusted network has traditionally been a fixed perimeter. This concept is no longer adequate because systems routinely cross between untrusted and trusted networks. An infected system can quickly infect other systems on the network after catching a virus on the Internet. The corporate network, for example the Local Area Network (LAN), is especially vulnerable because network resources are more open and prevalent. To remain safe and productive, the network should ensure that all systems are compliant with corporate security policies without impeding workflow.

A dramatic upsurge in the number of security incidents has been observed in the last few years, along with an increase in the severity of such incidents (worms, viruses, etc.). The Computer Emergency Response Team (CERT) recorded 319,992 security incidents between 1988 and 2003, with 272,281 of such incidents being reported between 2001 and 2003 (85% of the total number of incidents).

Furthermore, the delay between discovering a “security hole” in today's desktop operating systems and software and the occurrence of an associated security incident, such as a virus exploiting such a hole, has gone from months to just a few days. For example, in 2003, it took hackers only 26 days to exploit a flaw in a Microsoft operating system software and to eventually flood the Internet with the “Blaster” worm.

As the exploit windows continue to shrink, that is as the time span between the discovery of the vulnerability and the appearance of an exploit shortens, “zero-day threats” may be on the horizon. Zero-day threats are those that target vulnerabilities before they are announced and before patches are available. Needless to say, these viruses are the most dangerous, and are difficult to contain.

Furthermore, hackers are no longer simply looking for notoriety since attacks seeking confidential information (such as credit card numbers, passwords, and encryption keys) grew 519% during the last half of 2003. They also accounted for 78% of all Symantec's top 10 submissions, up from just 22% in the first six months of 2003.

With enhanced productivity In mind, organizations often exploit Local Area Networks in “self-serve” mode, thus allowing pretty much anyone to walk in and hook themselves to the corporate network (in meeting rooms, empty cubicles, lobbies, through wireless access, etc.). In doing so, such end-users are automatically provided with an IP address, which, in turn, gives them access to local resources (intranet, printers, Internet, etc.). However, since a desktop can be assigned an IP address within a few seconds of “booting”, it then becomes vulnerable to attacks and involuntarily turns into a security threat to the other network users and to the Corporate Network integrity.

IT departments find themselves under Increasing pressure to provide more services with reduced staff. As such, both “controlled” and “uncontrolled” desktops that have physical or wireless access to the corporate network are automatically provided with an IP address.

Most security appliances currently available by merchants verify compliance of the devices on the network once the network connection is established and the device is on the corporate network to be protected. If the device is determined not to comply, its connection to the network is disabled and the intruder is prevented from accessing the network resources. These systems are operating at Open System Interconnection (OSI) Layer 3 network or higher.

A vulnerable desktop can become a threat as soon as it has obtained an IP address, which, typically, is within seconds of booting and/or plugging into the corporate network. As a consequence of this, any solution that acts on OSi Layer 3 and above evidently has let the workstation accessed the corporate network and, as such, has let it represent a vulnerability to neighboring resources (in other words, the network integrity can be compromised).

In one of his recent report, Gartner Group's security analysts offer the following recommendations in terms of protective measures against viruses and worms: “As soon as infected PCs attach to the internal network, worms can infect vulnerable internal PCs and servers within minutes. Scanning after a full network connection Is established is too late, because attacks from a corrupted system can begin immediately at connection. Because some internal PCs and servers will always be in vulnerable states, security policies must be enforced before network connections are established.” M. Nicolet, J. Pescatore, J. Girard, “Scan, Block and Quarantine to survive worm attacks” published in Jan. 26, 2004 by Gartner Group.

### SUMMARY OF THE INVENTION

The “Block and Scan” method is a solution to preserving network integrity and preventing vulnerabilities which affect the corporate network resources. This method consists in “Blocking” any workstation from entering the corporate network, that is blocking it before it obtains an IP address, and “Scanning” it to make sure it is compliant with corporate policies (operating systems, hot fixes, security patches, antivirus software, etc.) Only then (once deemed compliant) is the workstation allowed to enter the network. In order to achieve this goal, the present invention acts at the Ethernet Switch port level.

The present Layer-2 Network Appliance Solution protects existing corporate networks by only giving access to compliant workstations and by keeping vulnerable systems out. Non-compliant desktops and laptops can be automatically warned and/or quarantined until remediation. Unlike endpoint enforcement solutions, the present invention restricts access for all non-compliant workstations, even those without the agent software (uncontrolled) of the present invention, which ensures the integrity of the corporate network. Coupled with centralized updates, the present invention ensures a safe network by enforcing policies immediately after activation.

According to one broad aspect of the present invention, there is provided a method for verifying compliance of a device wanting to access a corporate network and OSI layer 2 connecting of the device using the compliance verification. The method comprises installing an agent software on the device; detecting a boot-up of the device; providing the device with a temporary IP address upon boot-up, the temporary IP address being within a compliancy network, logically separate from the corporate network; providing a list of compliance rules to be verified for the device; sending the agent the list of compliance rules; verifying a state of the device for each rule; transmitting a result of the state obtained for each compliance rule; deciding on compliance of the device using the result; instructing a switch port at OSI layer 2 to connect the device to the corporate network if the decision determines compliance; instructing a switch port at OSI layer 2 to connect the device to a network logically separate from the corporate network in case of non-compliance.

According to another broad aspect of the present invention, there is provided a system for verifying compliance of a device wanting to access a corporate network and OSI layer 2 connecting of the device using the compliance verification. The system comprises a boot-up detector for detecting a boot-up of the device; a device session communicator for communicating that the boot-up is detected to a compliancy appliance; a compliancy appliance session communicator for at least one of transmitting data to and receiving data from the device session communicator; a temporary IP address sender for providing the device with a temporary IP address upon boot-up, the temporary IP address being within a compliancy network, logically separate from the corporate network; an IP address manager for attributing the temporary IP address to the device; a compliance rules provider for providing a list of compliance rules to be verified for the device; a compliance verifier for verifying a state of the device for each compliance rule; a compliance decision maker for deciding on compliance of the device using the result; a switch connection provider for instructing a switch port at OSI layer 2 to connect the device to the corporate network if the decision determines compliance and for instructing a switch port at OSI layer 2 to connect the device to a network logically separate from the corporate network in case of non-compliance.

In the present application, the term “corporate network” is intended to cover a Local Area Network (LAN), a Metropolitan Area Network (MAN) and a Wide Area Network (WAN). It includes wired and wireless connections to the network. The term “LAN” is used loosely for the preferred embodiment of the present invention although the invention is intended to be used with corporate networks in general. The term “LAN” should not be taken in its more restrictive sense but rather should be replaced by corporate networks to understand the breath of the description.

### BRIEF DESCRIPTION OF THE DRAWINGS

Further features and advantages of the present Invention will become apparent from the following detailed description, taken in combination with the appended drawings, in which:

FIG. 1 is a block diagram of the physical components of the prior art infrastructure;

FIG. 2 is a block diagram of the physical components of the Infrastructure according to a preferred embodiment of the present invention;

FIG. 3 is a block diagram of the main internal software components of the Compliancy Security Agent (CSA) side and the Compliancy Appliance Server (CAS) side according to a preferred embodiment of the present invention;

FIG. 4 is a flow chart of the main steps of the process according to a preferred embodiment of the present invention; and

FIG. 5, FIG. 6, FIG. 7 and FIG. 8 are detailed flow charts of the preferred steps of the process according to a preferred embodiment of the present invention.

It will be noted that throughout the appended drawings, like features are identified by like reference numerals.

### DETAILED DESCRIPTION OF THE PREFERRED EMBODIMENT

A virtual LAN (VLAN) is a logical subgroup within a local area network (LAN) that is created via software rather than manually moving cables in the wiring closet. It combines user stations and network devices into a single unit regardless of the physical LAN segment they are attached to and allows traffic to flow more efficiently within populations of mutual interest. VLANs are implemented in port switching hubs and LAN switches and generally offer proprietary solutions. VLANs reduce the time it takes to implement moves, adds and changes.

Open System Interconnection (OSI) is an ISO standard for worldwide communications that defines a framework for implementing protocols in seven layers. Control is passed from one layer to the next, starting at the application layer in one station, proceeding to the bottom layer, over the channel to the next station and back up the hierarchy.

Layers 3 through 1 are responsible for moving packets from the sending station to the receiving station.

Physical Layer 1

The physical layer is responsible for passing bits onto and receiving them from the connecting medium. This layer has no understanding of the meaning of the bits, but deals with the electrical and mechanical characteristics of the signals and signaling methods.

Data Link Layer 2

The data link is responsible for node to node validity and integrity of the transmission. The transmitted bits are divided into frames; for example, an Ethernet, Token Ring or FDDI frame in local area networks (LANs). Frame relay and ATM are also at Layer 2. Layers 1 and 2 are required for every type of communications.

Network Layer 3

The network layer establishes the route between the sender and receiver across switching points, which are typically routers. The most ubiquitous example of this layer is the IP protocol in TCP/IP. IPX, SNA and AppleTalk are other examples of routable protocols, which means that they include a network address and a station address in their addressing system. This layer is also the switching function of the dial-up telephone system. If all stations are contained within a single network segment, then the routing capability in this layer is not required.

Transport Layer 4

This layer is responsible for overall end to end validity and integrity of the transmission. The lower layers may drop packets, but the transport layer performs a sequence check on the data and ensures that if a 12 MB file is sent, the full 12 MB is received.

“OSI transport services” include layers 1 through 4, collectively responsible for delivering a complete message or file from sending to receiving station without error.

Layers 7 through 4 comprise the upper layers of the OSI protocol stack. They are more geared to the type of application than the lower layers, which are designed to move packets, no matter what they contain, from one place to another.

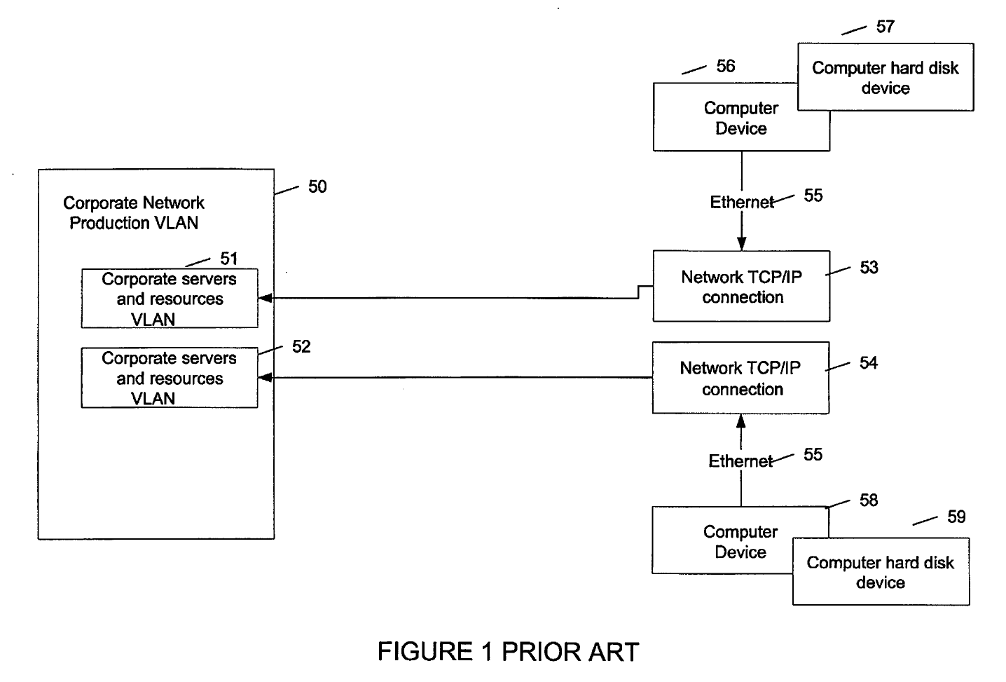

FIG. 1 is a block diagram of the physical components of the prior art infrastructure. A corporate network production VLAN 50 comprises corporate servers and resources VLAN 51 and corporate servers and resources VLAN 52. Two computer devices 56 and 58 each having a computer hard disk device 57 and 59 are connected through an Ethernet 55 to network TCP/IP connections 53 and 54.

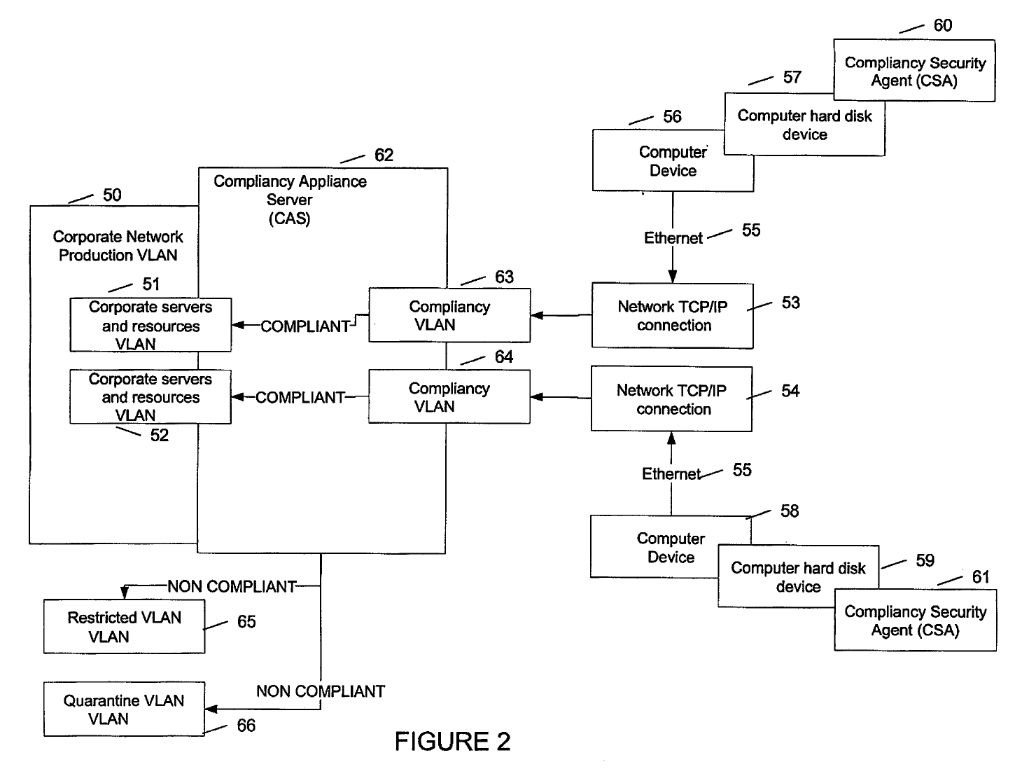

FIG. 2 is a block diagram of the physical components of the infrastructure according to a preferred embodiment of the present invention. The present invention is composed of a OSI Layer-2 Network Appliance, the “Compliancy Appliance Server” (CAS) deployed centrally within the corporate network along with a lightweight Compliancy Security Agent (CSA) software installed on the workstations.

A corporate network production VLAN 50 comprises corporate servers and resources VLAN 51 and corporate servers and resources VLAN 52. A compliancy appliance server 62 comprises a compliancy VLAN (CVLAN) 63 and a compliancy VLAN (CVLAN) 64, one for each corporate VLAN previously identified. A restricted VLAN (RVLAN) 65 and Quarantine VLAN (QVLAN) 66 are also provided. Two computer devices 56 and 58 each having a computer hard disk device 57 and 59 and each having a compliancy security agent (CSA) 60 and 61 are connected through an Ethernet 55 to network TCP/IP connections 53 and 54.

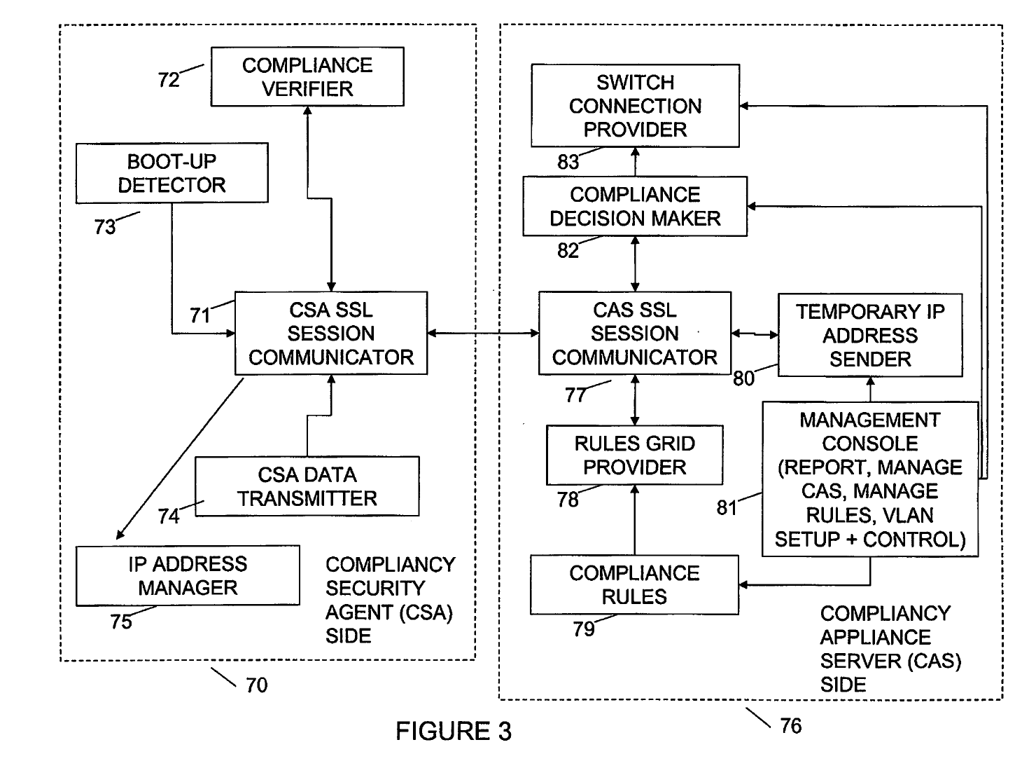

FIG. 3 is a block diagram of the main internal software components of the Compliancy Security Agent (CSA) side and the Compliancy Appliance Server (CAS) side according to a preferred embodiment of the present invention.

The Compliancy Security Agent (CSA) side 70 comprises a Secure Sockets Layer (SSL) session communicator 71 which receives an indication from the boot-up detector 73 that the device has boot up. It then communicates with the compliance verifier 72 to obtain the compliance verification results. The CSA data transmitter 74 provides information concerning the device to the SSL session communicator 71. The IP address manager 75 is used to change the IP address of the device.

The Compliancy Appliance Server (CAS) side 76 comprises a CAS SSL session communicator 77 which communicates with the CSA SSL session communicator 71. It receives a rules grid from the rules grid provider 78 which obtains compliance rules 79 for use with the device. A temporary IP address sender 80 determines an appropriate IP address for the device and a management console 81 is used to report, manage the CAS, manage the rules, perform the VLAN and CVLAN setup and control the system. A compliance decision maker 82 receives the data from the device and determines compliancy. It then communicates with the switch connection provider 83 for switching the device on the appropriate VLAN.

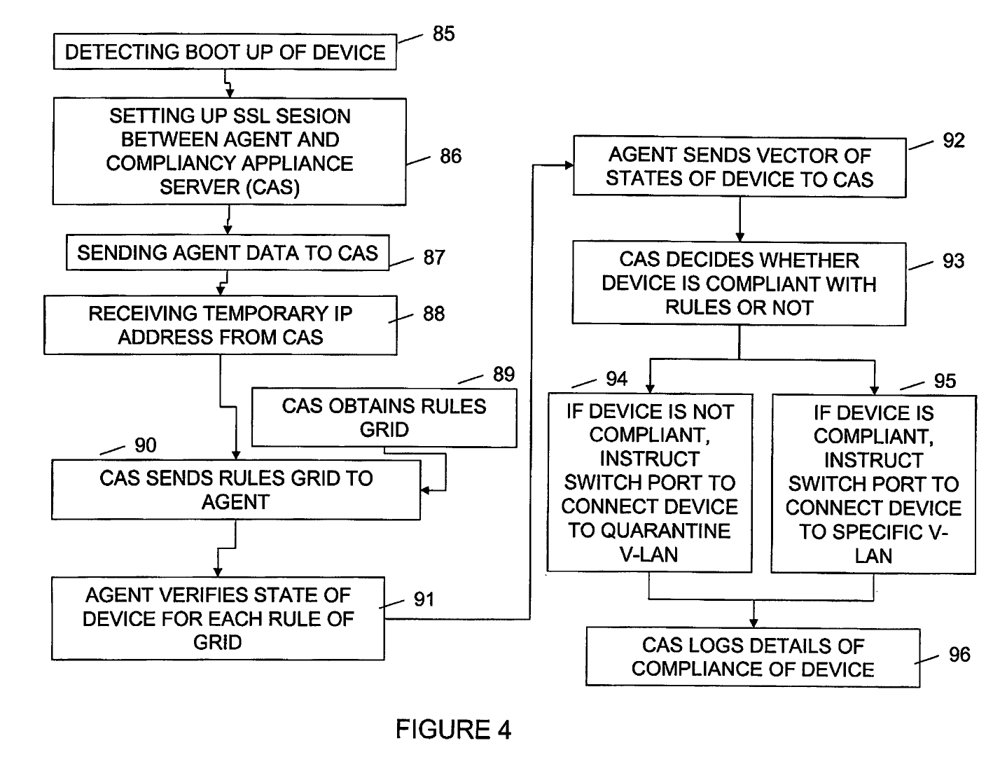

FIG. 4 is a flow chart of the main steps of the process according to a preferred embodiment of the present invention. The CAS operates as soon as a workstation plugs itself into any network port and a boot up of the device is detected 85. A SSL session between the CSA and the CAS is set up 86. At this point, the CAS transparently isolates 87, 88 the workstation within a “Compliancy VLAN” (external to corporate resources) and performs 89, 90, 91, 92 a compliancy scan within a few milliseconds. Based on the result of this scan 93, the workstation is then redirected either to its adequate “Production VLAN” (if deemed compliant) 95 or, alternatively, it may be redirected to either a “Restricted VLAN” with access to limited resources and where repairs and patch uploads may take place, or a “Quarantine VLAN” to quarantine the workstation 94. All of these actions are performed based on the compliancy scanning results and depend on the security policies programmed in the CAS by the corporate network administrators and security analysts. Appropriate logs of the compliance verification are taken 96.

The CAS does this process of blocking, redirecting and scanning transparently and extremely rapidly, that is within a few milliseconds, with test benchmarks supporting up to 5,000 workstations per CAS and performing up to 200 compliance analysis per second.

The overall advantages of the present invention are as follows:
the CAS allows organizations to easily and rapidly define their workstation compliancy policies, that is what is allowed, what is tolerated and what is blocked, in terms of antivirus software, operating systems, and associated security patches and signature files;
once defined, the CAS provides corporate network administrators and security analysts the ability to publish and enforce predefined workstation compliancy policies (within a broader scope of corporate security policies);
the CAS also has the option of “notifying” end-users when their workstation are “no longer” compliant, thus warning employees of upcoming changes while allowing them to access network resources during a predetermined “grace period”;
the CAS also provides corporate IT personnel the ability to monitor and control the entire corporate fleet of devices (laptop, desktop, PDA, etc.) used by users accessing the network; and
the CAS provides traditional management and reporting functionalities.

The system Is preferably accessible within an administrator management interface, such as the Microsoft-based Management Console (MMC), which network and system administrators are already familiar with and use on a daily basis to monitor, manage and query desktops, laptops, servers, networks and other LAN resources. The features are preferably implemented in small software items called “snap-in”.

As will be seen from the figures, the present invention directly instructs the Ethernet switch port to connect the device onto the appropriate CVLAN thereby making an OSI Layer 2 intervention preventing the device from accessing the VLAN up until the compliance decision is made.

In terms of architecture, the CAS is preferably designed with the following standards, technologies and protocols:
UNIX-O/S based appliance (OpenBSD ver. 3.5) for the Network Kernel built on carrier-grade Intel servers with redundant components (power supplies, fans, hardware-based RAID storage, network interface cards);
Internal encryption & hashing (AES, 256 Bits), with RSA Security (1,024+Bits), SHA256 & secure sockets layer for the communication protocol (SSL ver. 3);
Security certificate PKCS #7 and PKCS #12 and compliant with ISO standards (IS0031, IS0639-2, IS08859-1 & IS010646); Industry-grade management interface (SNMP ver. 2 and 3) with reliable mechanisms for syslog delivery (RFC3195) and standards-based information format (xHTML 1.1, HTML 4.01 and PDF v.4);
250 V Electrical power with an estimated consumption of 15 Amps.

In terms of its operational features, the CAS preferably comes bundled with all of the required services and daemons (DHCP, DNS, HTTPd, SNMP MIBs, etc.), true to the spirit of a functional appliance. The software CSA that resides on the devices is preferably written in pure C for performance and portability reasons. An agent-less version also preferably exists whereby a lightweight signed component is downloaded by “guest users” upon physical connection to the network.

As will be readily understood, as soon as a required rule is not complied with by a device, the device is deemed non-compliant. The only way to make this device compliant again is by having the device go through the same compliancy verification process and ignoring the previous non-compliant state. Corrections are made to the device and the process is repeated until the device is deemed compliant. The corrections (remediation) can be made manually or automatically depending on the network settings.

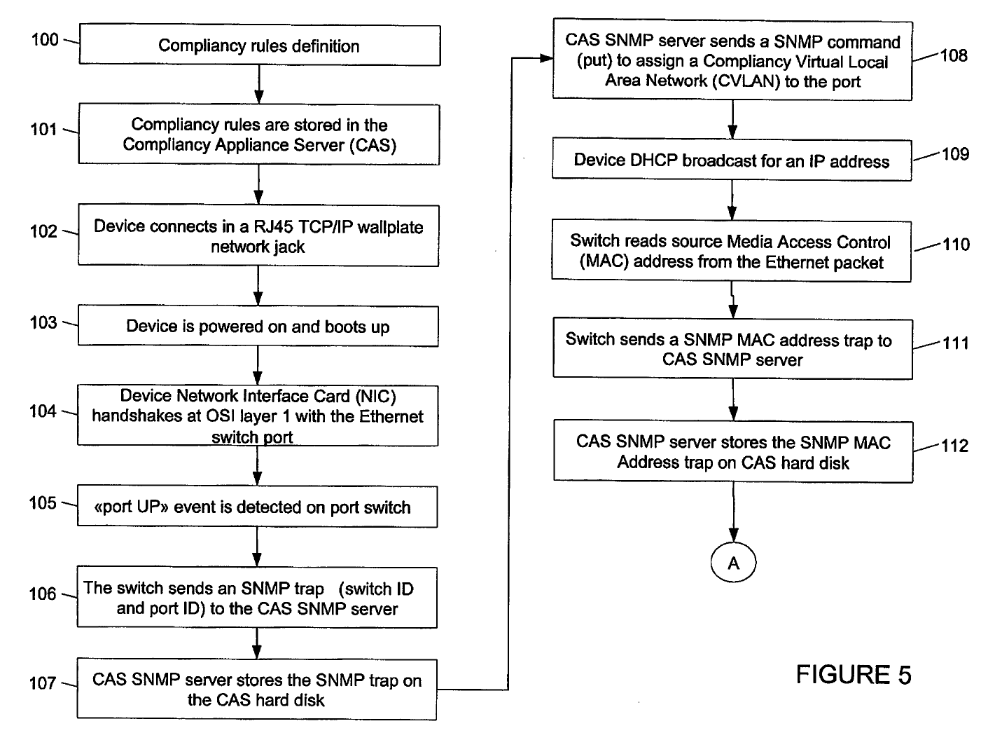

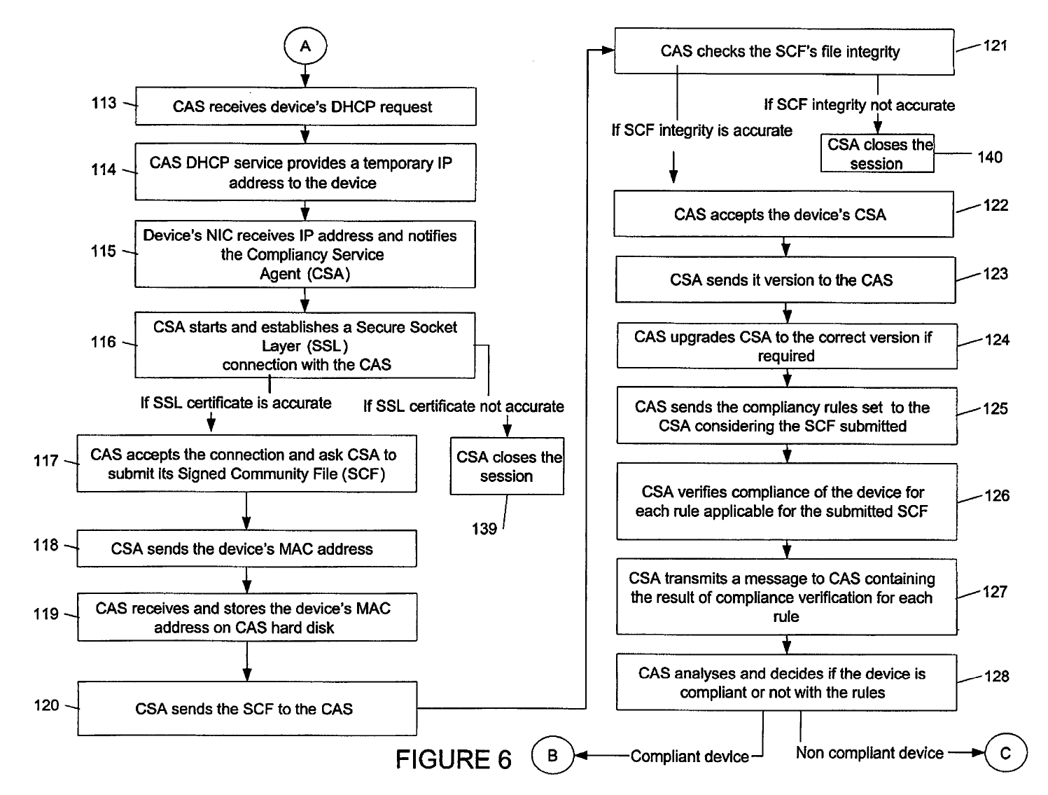

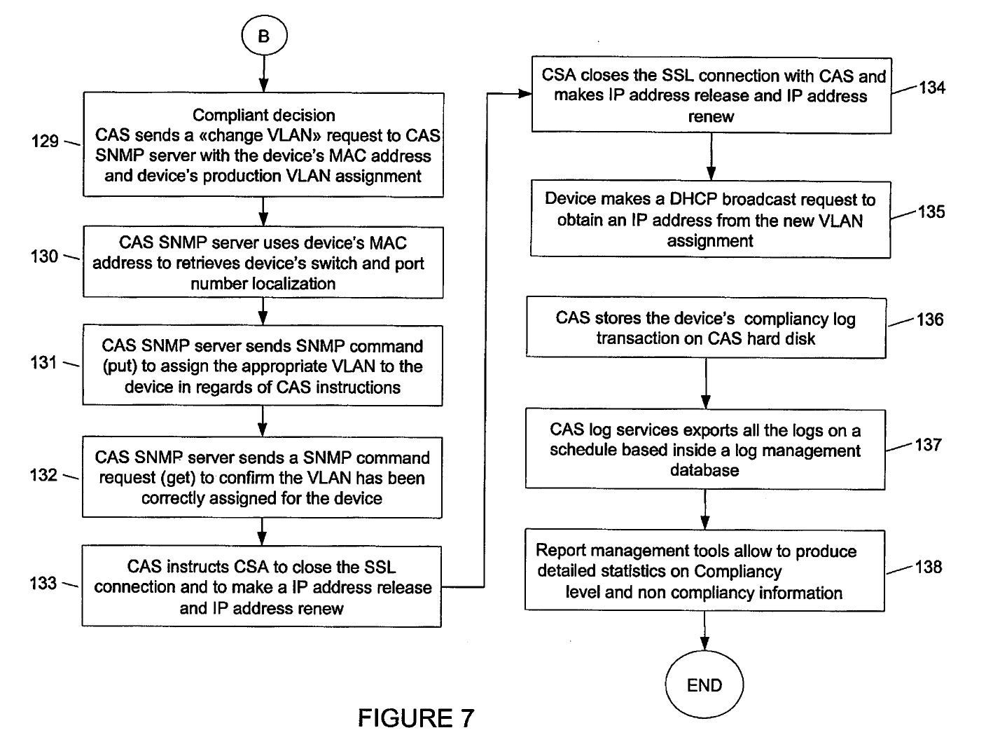

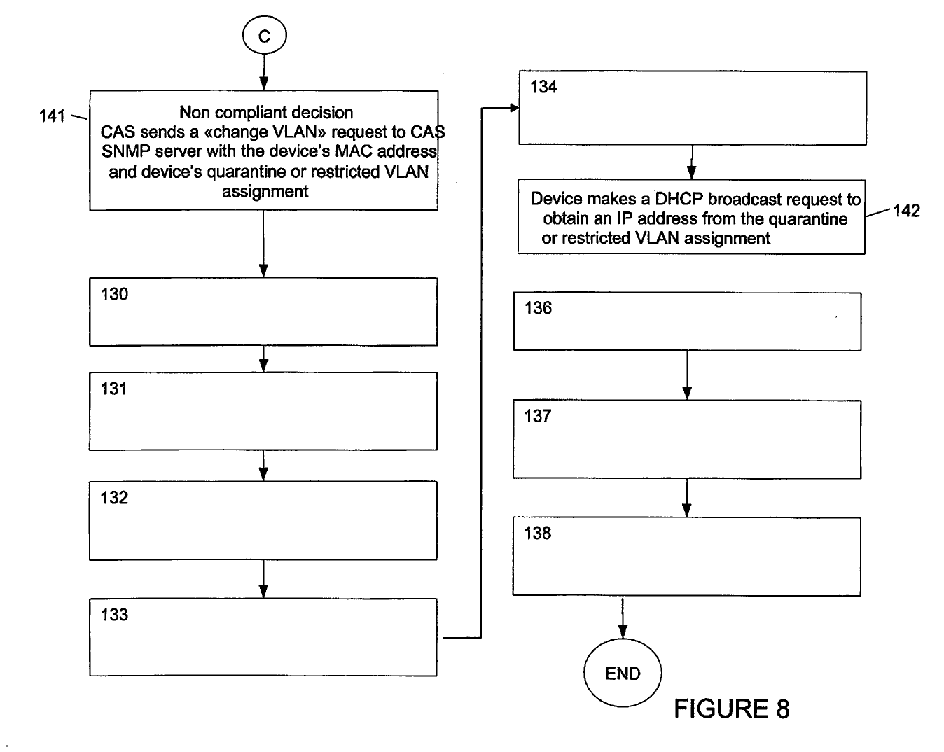

Referring now to FIG. 5, FIG. 6, FIG. 7 and FIG. 8, a detailed description of each step preferably carried out by the system is provided.

Step 100—Compliancy Rules Definition

This step preferably makes use of a client software to define Corporate Compliancy Rules (CCR). Sets of CCR are defined for different communities. Communities are a group of devices which share the same level of IT Security risk and are grouped within a community identifiant. It is possible to define an unlimited number of communities. A CCR is a compliancy process through which is checked a state of the device. It therefore includes information concerning all the OS patches, the Antivirus, the spyware, the versions of any piece of software, etc. The state can be the presence or absence of any information on the device. The information can be any electronic format of data sitting on a Computer hard disk device or in a memory of a Computer device.

Step 101—Compliancy rules are stored in the Compliancy Appliance Server (CAS).

Once CCR are defined for each community, the rules are uploaded to the Compliancy Appliance Server (CAS) 101. The Compliancy verification process can be started.

Step 102—Device connects in a RJ45 TCP/IP wallplate network jack

Any Computer device connecting in a TCP/IP network is detected. Often, the connection will be a RJ45 TCP/IP wallplate network jack. At this point, there is no power on the device and no other services is on.

Step 103—Device is powered on and boots up.

The device is powered on and starts its boot up process. It creates an event at Network OSI layer 1 Physical which is an electricity detection between the device and an Ethernet port switch.

Step 104—Network Interface Card (NIC) handshakes at OSI layer 1 with the Ethernet switch port.

At this point, the NIC card of the device will handshake with the Ethernet switch port and the device will send a first Ethernet TCP/IP packet.

Step 105— [symbol] port up [symbol] event is detected on port switch.

The operating system of the Ethernet switch detects an electrical activity and creates a [symbol] port up [symbol] event meaning that there Is activity on the Ethernet switch port. At this point, the Ethernet switch, on which the device is connected, will read the first TCP/IP packet sent by the device and will create a [symbol] port up [symbol] event on the network.

Step 106—The switch sends a Simple Network Management Protocol (SNMP) trap (Switch ID and port ID) to the CAS SNMP server.

The Ethernet port switch detects the first TCP/IP packet. Proper Ethernet switch port configuration creates a SNMP trap on such a [symbol] port up [symbol] event. The SNMP trap is configured to be sent to the CAS IP address.

Step 107—CAS SNMP server stores the SNMP trap on the CAS hard disk.

CAS SNMP server receives the SNMP trap sent by the Ethernet switch and stores the SNMP trap on the CAS SNMP hard disk. The SNMP trap information includes the Ethernet switch ID and the Ethernet switch port ID allowing to localize where the device is connected.

Step 108—CAS SNMP server sends a SNMP command (put) to assign a Compliancy Virtual Local Area Network (CVLAN) to the port.

CAS SNMP server retrieves in its database, the predefined Compliancy Virtual Local Area Network (CVLAN) to be assigned for the Ethernet switch port. The CAS sends a SNMP command (put) to the Ethernet switch, where the device is connected, to assign a Compliancy Virtual Local Area Network (CVLAN) to the Ethernet switch port where the device is connected.

A CVLAN is created for each VLAN in order to respect best practices recommended by switch manufacturers. When a device is placed in a VLAN, the switch informs all other switches of the same subnet of the change in status of each of its ports with respect to that VLAN. In the case of one CVLAN per production VLAN, this is not demanding on the system since it is limited to a small subnet. In the case where only one CVLAN would be used for all production VLAN, and in the exception situation of a power failure, all devices on the network would be simultaneously put on the same CVLAN. The switches would then all try to communicate the change in status of their ports and would create a system overload, called a spanning tree effect. Therefore, if there are 200 VLAN in the network there will need to be created 200 CVLAN. Each VLAN does not exceed 256 devices.

Step 109—Device DHCP broadcast for an IP address.

The Device DHCP service broadcasts the network to obtain an IP address from the DHCP server.

Step 110—Switch read source Media Access Control (MAC) address from the Ethernet packet.

The first TCP/IP packet sent by the device DHCP service is read by the Ethernet switch port. The Ethernet switch port will read and extract from the TCP/IP packet the device MAC address. The Ethernet switch port is configured to send an SNMP trap to the CAS SNMP server containing the Ethernet switch ID, the Ethernet switch port ID and the device MAC address.

Step 111—Switch sends an SNMP MAC address trap to CAS SNMP server.

The Ethernet switch sends the SNMP trap to the CAS IP address.

Step 112—CAS SNMP server stores the SNMP MAC address trap on CAS hard disk.

The CAS SNMP server retrieves in its database the [symbol] Ethernet switch ID+Ethernet switch port ID [symbol] record and stores the MAC address of the device connected in this port.

Step 113—CAS receives device DHCP request

All the CVLAN created in the network are restricted using a router access list, to a single IP address. This IP address is the CAS one and the CAS is located in a VLAN connected on the core switch. Therefore, all CVLAN can see the CAS. The CAS has also a NIC connected in the core switch allowing the CAS to see all VLAN in the network.

Step 114—CAS DHCP service provides a temporary IP address to the device.

CAS has its own DHCP service. CAS DHCP service assigns a temporary IP address to any device DHCP service which broadcasted for an IP address. CAS DHCP service maintains a IP address scope (a class C range) for each CVLAN. For instance, a CVLAN has an IP scope from 10.10.100.001 to 10.10.100.255.

Step 115—Device NIC receives IP address and notifies the Compliancy Service Agent (CSA).

Once the CAS DHCP service returns an IP address in response to the device DHCP broadcast request, the NIC card will notify the Compliancy Service Agent (CSA). CSA is configured with a dependency on the [symbol] netlogon [symbol] event. Therefore, each time there is a netlogon event, the NIC card will notify the CSA. CSA, being an automated service, is up and running as soon the device boots up. The CSA is the first one to act on the device before any other device network services.

Step 116—CSA starts and establishes a Secure Sockets Layer (SSL) connection with the CAS

CSA establishes a Secure Sockets Layer (SSL) connection with the CAS.

Step 117—CAS accepts the connection and asks CSA to submit its Signed Community File (SCF).

If the device SSL certificate is accurate, the CAS accepts the SSL connection. Then, CAS requests from the CSA its Signed Community File (SCF). The SCF is a signed file allowing the CAS to determine which community the device is identified to and therefore which set of compliancy rules applies.

It is possible to define as many communities as the corporation needs. For instance, a set of communities can be as follows and each community is linked with a specific SCF which is present on the device:

SCF 0001: Visitor community

SCF 0002: Partner community

SCF 0003: Consultant community

SCF 0004: Regular staff community

SCF 0005: Low sensitive staff community

SCF 0006: High sensitive staff community

The Visitor community can allow to operate only a network access control without a full compliancy check. The device is put in a quarantine or restricted VLAN zone with only Internet access without any corporate network resource access.

In the Partner community, the devices are allowed to enter on the corporate network frequently but are not allowed to access sensitive resources. A single [symbol] presence of [symbol] Antivirus software may be sufficient.

For the Consultant community, depending on the level of access allowed to a consultant in the network corporation, the compliancy check for this community may be limited to the [symbol] presence of [symbol] up to date OS patches and up to date Antivirus software.

The regular staff community typically contains the highest number of devices within the corporation. Based on corporate IT security policies, the set of compliancy rules for this community will be much more thorough than that of visitors, consultants or partners because the staff will have access to most of the corporate network resources and confidential corporate information like client files.

The low sensitive staff community is a portion of the corporation's devices which have access to, all of the regular staff access, plus they have access to sensitive information and require a more in-depth set of compliancy rules. The more rules to verify, the longer the procedure takes. The SCF approach is established to balance the level of security check with the level of IT risk represented by the group of devices.

The high sensitive staff community typically represents a smaller group of devices than any other staff community. But for many IT security reasons and risk management reasons, this community requires an in-depth compliancy check before they can log on the corporate network. For instance, the high sensitive community can require the presence of a corporate IT certificate. For instance, in the previous example, the visitor community check can require 1 second of time to do the compliancy check while the high sensitive community check can require up to 5 minutes.

Step 118—CSA sends the device MAC address.

If SCF Integrity check is OK, then CSA sends the device MAC address to the CAS.

Step 119—CAS receives and stores the device MAC address on CAS hard disk.

CAS stores the device MAC address on its hard disk. The MAC address will be used later to instruct the switch port to change from the CVLAN to the production VLAN or to another VLAN depending the device's level of compliancy.

Step 120—CSA sends the SCF to the CAS

The CSA sends its Signed Community File (SCF) to the CAS. The SCF is a text file containing a number identifying the device's community, preferably an 18 digit number.

Step 121—CAS checks the SCF file integrity.

CAS checks the SCF integrity for a security purpose.

Step 122—CAS accepts the device CSA.

If the SCF integrity check is OK then the CAS accepts CSA compliancy request check for the device.

Step 123—CSA sends its version to the CAS.

The CSA checks with the CAS if the CSA version is accurate. CSA sends Its version number to the CAS which determines if the CSA version is accurate.

Step 124—CAS upgrades CSA to the correct version if required.

If the CSA version is not accurate, the CAS will transmit the CSA updated version to the device and CSA will auto update it.

Step 125—CSA sends the compliancy rules set to the CSA considering the SCF submitted.

CAS retrieves the compliancy rules set from its database depending with the SCF submitted by the CSA.

Step 126—CSA verifies compliance for the device for each rule applicable for the submitted SCF.

CAS sends to CSA a first set of rules referred to as [symbol] detection rules [symbol] . A detection rule is a rule which is able to identify different characteristics of the device such as:

The presence or the absence of:

Any Operating System (O/S) type and version;

Any Antivirus Software installed;

Any registry key data and state

Any file state on the hard disk (i.e. spyware)

Any file format or program (exe) size

Any file format or program (exe) date stamp

Any file format or program (exe) folder location

Any running process on the device

Any set up and configuration (i.e. bios) data

Any device or user identifier (i.e. certificate, cache file, Directory information, etc.)

The detection rules are used to tell the CAS on what type of device the compliance verification will be performed. A compliance verification for a Windows XP device may be different from one done on a Windows NT4 device. The CAS needs to know what type of device it is faced with before sending a set of rules to be verified. The detection rules are typically simple, such as the type and version of operating system, the make of antivirus software, etc. CSA sends the results of detection rules and CAS analyses the detection rule results, and determine and sends to the CSA the proper set of [symbol] compliancy [symbol] rules to check on the device.

CSA verifies the compliance of each rule in the set of rules transmitted by the CAS. Each rule result is stored in a Random Access Memory (RAM) with the number of the rule and the result (such as “pass or fail” or “true or false”) for each rule.

Compliancy rules can be the presence or the absence or the status of:

Any Operating System (O/S) type and version;

Any Antivirus Software installed;

Any registry key data and state

Any file state on the hard disk (i.e. spyware)

Any file format or program (exe) size

Any file format or program (exe) date stamp

Any file format or program (exe) folder location

Any running process on the device

Any set up and configuration (i.e. bios) data

Any device or user identifier (i.e. certificate, cache file, Directory information, etc.)

Any software status (i.e. Antivirus is up and running, personal firewall is activated, etc.)

In the case of the compliancy rule, the rule may be more specific than the detection rule. For example, in the case a Norton Antivirus software was detected in the detection rule, a version and signature file may be checked in the compliance rule to ensure that the proper virus definitions are used by the device.

Step 127—CSA transmits a message to CAS containing the result of compliance verification for each rule.

CSA, after checking all the compliancy rules status, transmits to CAS the results of each rule.

Step 128—CAS analyses and decides if the device is compliant or not with the rules.

CAS can manage many different types of rules, although three types have been found preferable as follows. First type of rule is an [symbol] informative [symbol] rule. Informative rules are used to track and store information on different states of the devices within a network. Informative rules are used to create statistics about the presence or not of any data, any software, data signature or device configuration or device setup of the device. A device which fails to respect an informative rule will be allowed to log on the corporate network without being blocked or quarantined. An informative rule is a silent rule meaning that the user of the device will not be prompted with information about the compliancy status of his device.

The second type of rules is [symbol] advisable [symbol] . Advisable rules are rules where the result of the compliancy is presented to the user of the device through a local web page in a HTML format. Depending on the corporate configuration of the CAS, the non compliant user can click on a HTML link to remediate to the non compliant status. The HTML link refers to the proper tool to fix the non compliant status of the device. The advisable rule is used when the user still has time to fix the non compliant status, therefore, a grace delay is allowed. A device which fails to respect an advisable rule will be allowed to log on the corporate network without being blocked or quarantined.

The third type of rule is [symbol] required [symbol] . A required rule is a rule where a non compliancy will block the device from logging onto the network. The device is then put in quarantine until the time a remediation is applied. A non compliant device on a required rule will be prompted by an HTML page similar to that of the advisable rule. The user of the device will also be able, depending on the corporate configuration of the CAS, to click on a HTML link to remediate to the non compliant status. The device can also be fixed with a CAS automated integrated patch management tool or can require a human IT intervention.

Then the CAS has to analyze all the results of the compliancy check done by the CSA. The CAS decision about the compliancy is to check if all required rules are respected. For instance, a compliant device could be defined by a network administrator as a device having its O/S up to date with the latest Security OS patches from the manufacturer plus an Antivirus Software version up to date and up and running with the last signature file from the Antivirus manufacturer. In this example, the CAS would have four required rules. One rule for the O/S patches, one rule for the Antivirus Software version, one rule to confirm if the Antivirus is running of the device and the last one to check if the Antivirus has the latest virus signature file from the Antivirus manufacturer.

A compliant device will have a successful compliancy verification if all four compliancy rules are respected. The CAS analyses all the rules and make the compliancy decision.

Step 129—Compliant decision

CAS sends a [symbol] change VLAN [symbol] request to CAS SNMP server with the device MAC address and device production VLAN assignment.

CAS maintains in its database for each CVLAN the correspondent production VLAN. A production VLAN is a VLAN within the corporate network allowing the device to have access to all corporate resources. By definition and network architecture, a CVLAN is outside and apart from the corporate VLAN because of the compliancy process required to protect corporate network integrity.

Step 130—CAS SNMP server uses device MAC address to retrieve device switch and port number localization.

Using the device MAC address, CAS SNMP retrieves the device localization in the network and its Ethernet switch ID and Ethernet switch port ID.

Step 131—CAS SNMP server sends SNMP command (put) to assign the appropriate VLAN to the device in regards of CAS instructions.

CAS SNMP server sends SNMP command (put) to the Ethernet switch and instructs the switch to change the port on that switch to be set to a another VLAN number send by the CAS SNMP server.

Step 132—CAS SNMP server sends a SNMP command request (get) to confirm the VLAN has been correctly assigned for the device.

CAS SNMP server sends a SNMP command request (get) to the Ethernet switch (get) to check which VLAN is assigned to a specific port on that switch and that way the CAS SNMP server is able to assure that the change of VLAN has been done correctly.

Step 133—CAS instructs CSA to close the SSL connection and to make a IP address release and IP address renew.

CAS instructs CSA to close the SSL connection and to make an IP address release and wait a number of second then start an IP address renew. The device is now in another VLAN and the temporary IP address is no longer valid. Doing an IP release deletes the temporary IP address. Doing an IP renew creates a broadcast DHCP request allowing the device to receive a valid IP address in the new VLAN assignment.

Step 134—CSA closes the SSL connection with CSA and makes IP address release and IP address renew.

This action realized by the CSA will delete the temporary address assigned by the CAS. Since, the device VLAN has been assigned to a production VLAN, the next action IP renew will initiate a DHCP broadcast from the device.

Step 135—Device makes a DCHP broadcast request to obtain an IP address from the new VLAN assignment.

The DHCP broadcast will be caught by the Corporate DHCP server and a production IP address will be send to the device.

Step 136—CAS stores the device compliancy log transaction on CAS hard disk.

CAS stores the device compliancy log transaction on CAS hard disk.

Step 137—CAS log services exports all the log on a scheduled based inside a log management database.

CAS log services exports all the logs on a scheduled based inside a log management database. The log services export can be configured to work at every number of minutes or hour.

Step 138—Report management tools allow to produce detailed statistics on compliancy level and non compliancy information.

From a standard relational database, all compliancy check transactions are stored with dates and all related information allowing all kinds of management reports.

Step 139—CAS closes the connection.

If the SSL certificate Is not accurate, CAS closes the connection and sends the appropriate SSL standard error message to the device. The device will have to be fixed by the user in order to perform the compliancy check once again. Therefore, the device stays in the CVLAN.

Step 140—CAS closes the connection.

If the SCF integrity is not accurate, the CAS interrupts the process and sends an error message to the CSA. The device stays in the CVLAN, meaning that the device is quarantined because it has no corporate network access. The reason for a non accurate integrity of the SCF is typically a user's attempt to change his community signed file to lower or try to avoid the compliancy check.

Step 141—Non compliant decision

If the device is not compliant, CAS sends the device (assigns the port VLAN) In quarantine VLAN or in a restricted VLAN outside the corporate network. In quarantine VLAN there is no service but the device can still communicate with the CAS in case the device has been fixed and wants to restart the compliancy check. In case of restricted VLAN services, the device is placed in a part of the corporate network with limited resources like Internet access in order to protect corporate network integrity.

CAS sends a [symbol] change VLAN [symbol] request to CAS SNMP server with the device MAC address and device production VLAN assignment.

CAS maintains in its database for each CVLAN the correspondent quarantine and/or restricted VLAN services.

Step 142—Device makes a DCHP broadcast request to obtain an IP address from the new VLAN assignment.

In the case of quarantine VLAN and restricted VLAN, those VLAN are outside the corporate network and under CAS control. The CAS is still accessible for the devices, therefore, it is the CAS DHCP services which attributes another temporary IP address to the device in a quarantine or restricted VLAN. Doing so, the non compliant devices can all the time restart the compliancy check.

### EXAMPLES

A detailed example for a compliant device with a SCF 002 partner type community is as follows:

Device boots up, Ethernet switch emits a port up event, Ethernet switch sends a SNMP trap, CAS SNMP Receives SNMP trap, CAS SNMP Stores SNMP trap, CSA Sends device MAC address to CAS, CAS SNMP assigns CVLAN to the device, CSA initiates SSL connection, CAS requires CSA to submit SCF, CSA submit SCFOO2 Partner to CAS, CAS checks and accepts SCF integrity, CAS sends CSA detection rules, CSA sends detection rules results Which OS, AV, etc., CAS receives detection rules saying device is Windows XP Service Pack 2 with Norton Antivirus.

CAS sends the set of rules for SCF 002 with Compliancy rules for Windows XP and Norton Antivirus (NAV):

Required rules:

OS security patches KB0012=version 1.3 Expected result: True

OS security patches KB0013=version 1.6 Expected result: True

NAV Software version=8.0 Expected result: True

NAV signature file dated=2005-03-01 Expected result: True

Advisable rules:

Presence of Kazaa software Expected result: False

Informative rules:

Presence of spyware bot Expected result: False

CSA makes compliancy check to all the rules and sends the results to CAS.

The results are:

Required rules:

Win XP SP 2=true

OS security patch KB0012=true

OS security patch KB0013=true

NAV version=true

NAV signature file=true

Advisable rules:

Presence of Kazaa=true

Informative rules:

Presence of spyware=true

CAS analyses the results and declare device compliant because the all the required rules are as expected, meaning that the device can access the corporate network even if there is the presence of Kazaa software and the presence of spyware which can represent a IT risk but for this example does not require to cut the level of service. However, this information can mean that an IT specialist is informed in the compliancy log and can schedule another process to remediate to the presence of Kazaa and spyware.

CSA SNMP instructs Ethernet switch port to assign the production VLAN to the device, CSA does an IP release and IP renew, Device DHCP broadcasts for IP address, Device receives DHCP corporate network IP address and operates onto the corporate network.

A detailed example for a non-compliant device with a SCF 002 partner type community is as follows:

The steps listed in paragraphs 159 to 161 are the same.

The results are:

Required rules:

Win XP SP 2=true

OS security patch KB0012=true

OS security patch KB0013=false

NAV version true

NAV signature file=true

Advisable rules:

Presence of Kazaa=true

Informative rules:

Presence of spyware=true

CAS analyses the results and declares the device non compliant because all of the required rules are not equal to the expected result. The device cannot access the corporate network. The patch KB0013 is not acceptable as per the compliancy rules of the network. The device is assigned to a quarantine VLAN and requires either manual or automatic remediation. After remediation, the device should reboot or the CSA should restart to make another compliancy check on this device.

CSA SNMP instructs Ethernet switch port to assign the quarantine VLAN to the device. CSA IP release and IP renew. Device DHCP broadcast for IP address. Device receives a new temporary IP address from the CAS DHCP service and cannot access the corporate network until remediation.

An exception case needs to be detailed further. The agentless situation will occur during operation of the system. A device which is not previously provided with an agent software will try to connect to the corporate network. The agentless case will be encountered with visitors who want to connect on the corporate network. Because visitors are typically very short time users, it is not convenient to install an agent software on their device. Typically, visitors log on corporate networks for periods of time as short as three hours, often in a meeting room. However, even if the visitor's device presence on the network is short, visitor devices are considered to be one of the highest risk of contamination because corporate IT staff does not know the state of the device in terms of security.

Most of the time, the corporate configuration will consider that the absence of a Signed Community File means, by default, that the device is a visitor device. A visitor will be automatically assigned to the quarantine VLAN. The user of the visitor device will not be able to know that his device is in a restricted VLAN before the device requests a corporate network resource. As soon as the device will start Internet Explorer, the CAS will catch any request and the CAS DNS service will redirect the device to a bottle neck HTML local page. The HTML page will explain to the user the presence of a compliancy environment and will ask the user for an acceptance of the compliancy verification conditions in order to carry out a compliancy verification on the device. The “I accept” click by the user will mean that the user accepts that the CAS will download a Signed ActiveX component which is the equivalent of the CSA software. The ActiveX component is stored on the visitor's device in a temporary folder and does the same compliancy verification steps than the other agent software. At the end of the compliancy verification, the device is redirected to the proper VLAN based on the device's compliancy and the temporary folder is deleted. This means that the download of the ActiveX component has to be repeated each time the same device will attempt to log on the network after a shut down since the CSA will not be present on the device's hard disk.

The embodiments of the invention described above are intended to be exemplary only. The scope of the invention is therefore intended to be limited solely by the scope of the appended claims.

What is claimed is:

1. A method for verifying compliance of a device wanting to access a corporate network and OSI layer 2 connecting of the device using said compliance verification, comprising:
installing an agent software on the device;
detecting a boot-up of the device;
providing the device with a temporary IP address upon boot-up, said temporary IP address being within a compliancy network, logically separate from said corporate network;
providing a list of compliance rules to be verified for the device;
sending the agent the list of compliance rules;
verifying a state of the device for each rule;
transmitting a result of said state obtained for each compliance rule;
deciding on compliance of the device using said result;
instructing a switch port at OSI layer 2 to connect the device to said corporate network if said decision determines compliance;
instructing a switch port at OSI layer 2 to connect the device to a network logically separate from the corporate network in case of non-compliance.

2. The method as claimed in claim 1, wherein said step of installing comprises downloading a small software component from a default web page triggered upon said providing a temporary IP address.

3. The method as claimed in claim 1, wherein said step of installing comprises installing a software component on said device prior to carrying out said compliance verification.

4. The method as claimed in claim 1, wherein said step of sending comprises using said temporary IP address.

5. The method as claimed in claim 1, wherein said step of verifying a state comprises retrieving a state of said device corresponding to said compliance rule and providing said state.

6. The method as claimed in claim 5, wherein said state is one of true and false in association with said compliance rule.

7. The method as claimed in claim 1, wherein said step of deciding on compliance comprises
identifying at least one rule of said list as being of a required type;
providing an expected state for each said rule;
obtaining said result;
for each rule of required type, determining if said result is said expected state for said rule;
if said result is said expected state, identifying said rule as being complied with;
if said result is not said expected state, identifying said rule as not being complied with;
if all rules identified as of a required type are complied with, determining said device to be in compliance;
if at least one rule identified as of a required type is not complied with, determining said device to be in non-compliance.

8. The method as claimed in claim 7, wherein said rule is identified as being of a type chosen from one of informative and advisable; and wherein said device is determined to be in compliance even if at least one rule identified as of one of information and advisable type is not complied with.

9. The method as claimed in claim 1, further comprising logging details of said compliance verification of said device.

10. The method as claimed in claim 1, wherein said instructing a switch port at OSI layer 2 to connect the device to the corporate network comprises
determining a network address corresponding to the requested corporate network;
using a MAC address of the device to retrieve a switch ID and port ID for the device;
sending command to switch to connect the appropriate network address to the device.

11. The method as claimed in claim 1, further comprising, upon said providing the device with a temporary IP address:
providing a list of detection rules to be detected for the device, said detection rules being aimed at obtaining a list of installed software contained in the device;
sending the agent the list of detection rules;
detecting said list of installed software contained in the device using each detection rule;
transmitting said list of installed software contained in the device;
and wherein said providing a list of compliance rules to be verified for the device comprises:
retrieving a subset of said compliance rules applicable to said list of installed software.

12. A system for verifying compliance of a device wanting to access a corporate network and OSI layer 2 connecting of the device using said compliance verification, comprising:
a boot-up detector for detecting a boot-up of the device;
a device session communicator for communicating that said boot-up is detected to a compliancy appliance;
a compliancy appliance session communicator for at least one of transmitting data to and receiving data from said device session communicator;
a temporary IP address sender for providing the device with a temporary IP address upon boot-up, said temporary IP address being within a compliancy network, logically separate from said corporate network;
an IP address manager for attributing said temporary IP address to said device;
a compliance rules provider for providing a list of compliance rules to be verified for the device;
a compliance verifier for verifying a state of the device for each compliance rule;
a compliance decision maker for deciding on compliance of the device using said result;
a switch connection provider for instructing a switch port at OSI layer 2 to connect the device to the corporate network if said decision determines compliance and for instructing a switch port at OSI layer 2 to connect the device to a network logically separate from the corporate network in case of non-compliance.

13. The system as claimed in claim 12, further comprising an agent downloader for downloading a small software component from a default web page triggered upon said providing a temporary IP address.

14. The system as claimed in claim 12, wherein said compliance verifier retrieves a state of said device corresponding to said compliance rule and provides said state.

15. The system as claimed in claim 12, wherein said state is one of true and false in association with said compliance rule.

16. The system as claimed in claim 12, wherein said compliance decision maker comprises
a type identifier for identifying at least one rule of said list as being of a required type;
an expected state provider for providing an expected state for each said rule;
a state matcher for determining if said result is said expected state for each rule of required type;
a rule compliance identifier for Identifying said rule as being complied with if said result is said expected state and identifying said rule as not being complied with if said result is not said expected state;
a decision compiler for determining said device to be in compliance if all rules identified as of a required type are complied with and determining said device to be in non-compliance if at least one rule identified as of a required type is not complied with.

17. The system as claimed in claim 16, wherein said rule is identified as being of a type chosen from one of informative and advisable; and wherein said device is determined to be in compliance even if at least one rule identified as of one of information and advisable type is not complied with.

18. The system as claimed in claim 12, further comprising a log maker for logging details of said compliance verification of said device, wherein said log maker logs said result and said determination of said decision compiler.

19. The system as claimed in claim 12, wherein said switch connection provider comprises
an address determiner for determining a network address corresponding to the corporate network;
a switch and port ID retriever for retrieving a switch ID and port ID for the device using a MAC address of the device;
a switch command sender for sending a command to switch to connect the appropriate network address to the device.

20. The system as claimed in claim 12, further comprising:
a detection rules provider for providing a list of detection rules to be detected for the device, said detection rules being aimed at obtaining a list of installed software contained in the device;
a detector for receiving said detection rules, detecting said list of Installed software contained in the device using each detection rule and transmitting said list of installed software contained in the device;
wherein said compliance rules provider comprises a subset retriever for retrieving a subset of said compliance rules applicable to said list of installed software.
